(19) United States
(12) Patent Application Publication
(10) Pub. No.: US 2007/0030676 A1
(43) Pub. Date: Feb. 8, 2007

(54) LIGHT-EMITTING MODULE AND LIGHT-EMITTING UNIT

(75) Inventor: Jun ICHIHARA, Ukyo-ku, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Ukyo-ku (JP)

(21) Appl. No.: 11/462,397

(22) Filed: Aug. 4, 2006

(30) Foreign Application Priority Data
Aug. 4, 2005 (JP) 2005-226071

(51) Int. Cl. F21V 5/00

(52) U.S. Cl. 362/244; 362/237; 362/240

(57) ABSTRACT

A light-emitting module includes a substrate, multiple light-emitting devices arranged thereon, and a package enclosing the multiple light-emitting devices. The package has multiple optical devices corresponding to the multiple light-emitting devices that converge and emit rays of light emitted from each of the light-emitting devices. When the outgoing rays of light emitted from the light-emitting device is extended toward the substrate, the package has virtual light-emitting regions spaced farther from the optical devices than the respective light-emitting devices, and the virtual light-emitting regions are located almost at the same position.

### BACKGROUND OF THE INVENTION

1. Field of the Invention

The present invention relates to a light-emitting module including light-emitting devices such as LED chips, and in particular, to a light-emitting module for use as a light source for various lighting fixtures.

2. Description of the Related Art

Recently, light-emitting modules containing multiple LED chips are used more commonly, replacing conventional incandescent lamps as a light source for indoor lighting fixtures, signals, and other devices. Such a light-emitting module containing multiple LED chips is described, for example, in Japanese Unexamined Patent Publication No. 11-17228 (Patent Document 1). The light-emitting module described in Patent Document 1 has a structure in which multiple light-emitting diodes (light-emitting units), in which the LED chips are sealed, for example, with a transparent resin, are aligned two-dimensionally. In the light-emitting module having such a configuration, the light intensity of the light-emitting module as a whole is generated by using multiple LED chips because the light intensity of a single LED chip is smaller than that of an incandescent lamp. Such a light-emitting module containing multiple LED chips has an advantage that the power consumption is lower and the life is longer than that of an incandescent lamp.

The light-emitting module described in Patent Document 1, which contains multiple LED chips aligned two-dimensionally, is suitable for use as a planar light source. However, in the configuration in which multiple LED chips are aligned two-dimensionally for obtaining a desired light intensity, it is not practically possible to use the light-emitting module as a point light source. That is, it was not possible to use such a light-emitting module containing multiple LED chips as a point light source having a relatively high light intensity, which unfavorably resulted in the restriction of the use of LED chips as a light source. In addition, in the light-emitting module described in Patent Document 1, multiple LED chips are observed as multiple dots separated from each other when the light-emitting module is observed visually as it is turned on. However, considering its application for indoor illumination, the appearance of the LED chips as multiple dots is unfavorable in quality compared to incandescent lamps in which light is emitted almost uniformly from the entire electric lamp. Although a measure to place a light-scattering unit in front of the light-emitting module may be taken, it often causes a problem of deterioration in the light intensity by diffusion of the emitted light.

### SUMMARY OF THE INVENTION

In order to overcome the problems described above, preferred embodiments of the present invention provide a light-emitting module including multiple light-emitting devices, such as LED chips, that prohibits or reduces the appearance of the light-emitting devices as separated multiple dots when turned on, is improved in quality as a light source for a lighting fixture, and can be used as a point light source having a relatively high light intensity.

According to a first preferred embodiment of the present invention, a light-emitting module includes a substrate, multiple light-emitting devices arranged thereon, and a package enclosing the multiple light-emitting devices; wherein the package has multiple optical devices corresponding to the multiple light-emitting devices that converge and emit rays of light emitted from each of the light-emitting devices; when the converged rays of light are extended toward the substrate, the package has a virtual light-emitting region spaced farther from the optical device than the light-emitting device; and the virtual light-emitting regions of respective rays are located almost at the same position.

In the light-emitting module having such a unique configuration, in which the virtual light-emitting regions corresponding to respective light-emitting devices are located almost at the same position such that they overlap each other, the light emitted from the light-emitting devices when turned on seems to come from a single virtual light-emitting region. Accordingly, with the light-emitting module having such a unique configuration, it is possible to improve the quality as a lighting fixture because the LED chips are not seen in a multiple dotted pattern as in conventional lighting fixtures using a light source having multiple LED chips. In addition, the light-emitting module in such a configuration, in which the light appears to be emitted from a single virtual light-emitting region, can be used as a point light source having a relatively high light intensity.

According to a second preferred embodiment of the present invention, a light-emitting module includes a substrate, multiple light-emitting devices arranged thereon, and a package enclosing the multiple light-emitting devices; wherein the package has multiple optical devices corresponding to the multiple light-emitting devices that converge and emit rays of light emitted from each of the light-emitting devices; when the converged rays of light are extended toward the substrate, the package has a virtual light-emitting region spaced farther from the optical device than the light-emitting device; the virtual light-emitting regions of the rays are located almost on the same plane; and the alignment pitch of the virtual light-emitting regions is smaller than the alignment pitch of the light-emitting devices.

In the light-emitting module having such a unique configuration, in which the virtual light-emitting regions corresponding to respective light-emitting devices are aligned almost on the same plane, the light from the light-emitting devices when turned on seems to come from a single virtual light-emitting region or adjacent multiple virtual light-emitting regions. In addition, the virtual light-emitting regions are observed as an integral region because the alignment pitch of the virtual light-emitting regions is made smaller than the alignment pitch of the light-emitting devices. Accordingly, with the light-emitting module in such a configuration, it is possible to improve the quality of lighting fixtures because the LED chips are not seen in a multiple dotted pattern as in conventional lighting fixtures using a light source having multiple LED chips. In addition, because the light from the light-emitting devices seems to come from an integral virtual light-emitting region, it is possible to use the module in the configuration above as a point light source having a relatively high light intensity.

According to a third preferred embodiment of the present invention, a light-emitting module includes multiple light-emitting units each including a substrate, multiple light-emitting devices arranged thereon, and a package enclosing the multiple light-emitting devices; wherein each of the packages has multiple optical devices that converge and emit rays of light emitted from each of the light-emitting devices; when the converged rays of light are extended toward the substrate, the package has a virtual light-emitting region spaced farther from the optical device than the light-emitting device; and the virtual light-emitting regions are located almost at the same position.

In the light-emitting module having such a unique configuration, in which the virtual light-emitting regions corresponding to respective light-emitting devices are located almost at the same position, the light emitted from the light-emitting devices when turned on seems to come from a single virtual light-emitting region. Thus, with the light-emitting module having such a unique configuration, it is possible to improve the quality of the lighting fixture because the LED chips are not seen in a multiple dotted pattern as in conventional lighting fixtures using a light source having multiple LED chips. In addition, because the light from the light-emitting devices seems to come from a single virtual light-emitting region in the light-emitting module in such a configuration, it is possible to use it as a point light source having a relatively high light intensity.

According to a fourth preferred embodiment of the present invention, a light-emitting module includes multiple light-emitting units each including a substrate, multiple light-emitting devices arranged thereon, and a package enclosing the multiple light-emitting devices; wherein each of the packages has multiple optical devices that converge and emit rays of light emitted from each of the light-emitting devices, and when the converged rays of light are extended toward the substrate, the package has a virtual light-emitting region spaced farther from the optical device than the light-emitting device; the virtual light-emitting regions are located almost on the same plane; and the alignment pitch of the virtual light-emitting regions is smaller than the alignment pitch of the light-emitting devices.

In the light-emitting module having such a unique configuration, in which the virtual light-emitting regions corresponding to respective light-emitting devices are aligned almost on the same plane, the light from the light-emitting devices when turned on seems to come from a single virtual light-emitting region or adjacent multiple virtual light-emitting regions. In addition, because the alignment pitch of the virtual light-emitting regions is smaller than the alignment pitch of the light-emitting devices, the virtual light-emitting regions are observed as an integral region. Thus, with the light-emitting module in such a configuration, it is possible to improve the quality of the lighting fixture because the LED chips are not seen in a multiple dotted pattern as in conventional lighting fixtures using a light source having multiple LED chips. In addition, because the light from the light-emitting devices seems to come from an integral virtual light-emitting region in the light-emitting module having such a unique configuration, it is possible to use it as a point light source having a relatively high light intensity.

In another preferred embodiment of the present invention, the light-emitting module additionally has a mold unit including a fluorescent substance that covers the light-emitting device. In such a configuration, the light-emitting module according to this preferred embodiment can be used as a white light source for lighting fixtures.

According to a fifth preferred embodiment of the present invention, a light-emitting unit includes a substrate, light-emitting devices arranged thereon, and a package enclosing the light-emitting device, wherein the package has multiple optical devices that converge and emit rays of light emitted from each of the light-emitting devices, and when the rays of light emitted from the light-emitting device and from each of the optical devices are extended toward the substrate, the package has virtual light-emitting regions spaced farther from the optical devices than the respective light-emitting devices.

The light-emitting unit having such a unique configuration also has the function described in the third or fourth preferred embodiment of the present invention.

In yet another preferred embodiment of the present invention, the light-emitting unit has a mold unit including a fluorescent substance that covers the light-emitting device. In such a configuration, the light-emitting unit according to this preferred embodiment can be used as a white light source for lighting fixtures.

In a preferred embodiment of the invention, the optical device is an optical lens.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a sectional view illustrating the main area of the light-emitting module in a preferred embodiment of the invention.

FIG. 2 is a schematic sectional view illustrating the light-emitting device and a corresponding optical lens in the light-emitting module shown in FIG. 1.

FIG. 3 is a schematic sectional view illustrating the light-emitting device and the corresponding optical lens in the light-emitting module shown in FIG. 1.

FIG. 4 is a sectional view illustrating the main area of a modification of the light-emitting module shown in FIG. 1.

FIG. 5 is a sectional view illustrating the main area of another modification of the light-emitting module shown in FIG. 1.

FIG. 6 is a sectional view illustrating the main area of the light-emitting module in another preferred embodiment of the present invention.

FIG. 7 is a sectional view illustrating the main area of the light-emitting module in yet another preferred embodiment of the present invention.

FIG. 8 is a schematic sectional view illustrating a light-emitting unit defining the light-emitting module shown in FIG. 5.

FIG. 9 is a sectional view illustrating the main area of the light-emitting module in yet another preferred embodiment of the present invention.

FIG. 10 is a sectional view illustrating the main area of the light-emitting module in yet another preferred embodiment of the present invention.

### DETAILED DESCRIPTION OF PREFERRED EMBODIMENTS

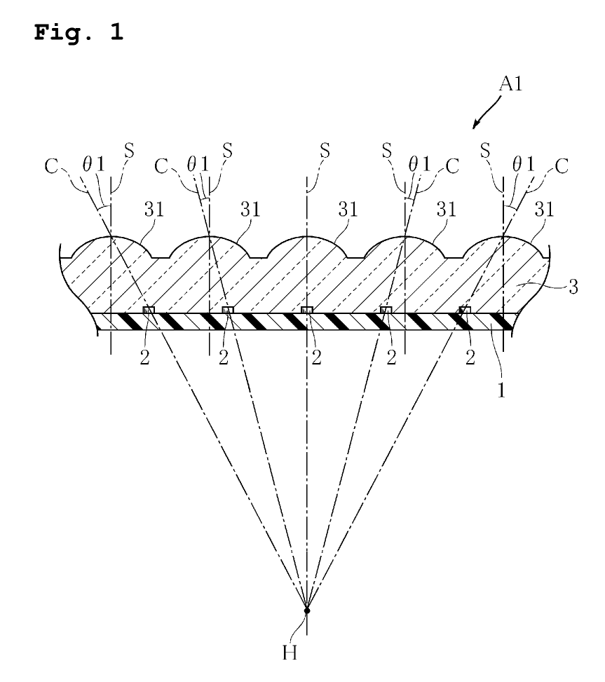

Hereinafter, preferred embodiments of the present invention will be described specifically with reference to the drawings. For convenience in description, the vertical direction will be determined with reference to FIG. 1.

FIGS. 1 to 3 are views illustrating the light-emitting module in a preferred embodiment of the present invention. The light-emitting module A1 in the present preferred embodiment has a configuration including a substrate 1, multiple light-emitting devices 2, and a resin or plastic package 3, which is favorable for use as a light source for various lighting fixtures.

The substrate 1 is preferably, for example, made of a glass epoxy resin and has a flat plate-shape. A common wiring (not shown in FIG. 1) is provided on the surface of the substrate 1. The common wiring is connected to a pair of electrodes of each light-emitting device 2 and also to a terminal for external connection (not shown in FIG. 1). Multiple light-emitting devices 2 are bonded to the common wiring on the substrate 1 at a certain pitch in a matrix pattern.

Each light-emitting device 2 is a light-emitting diode chip (LED chip) emitting, for example, blue light. The top surface electrode of each light-emitting device 2 and the common wiring pattern on substrate 1 are electrically connected to each other with a gold wire (not shown in FIG. 1), for example.

The resin package 3 is, for example, made of a transparent epoxy resin and is transparent to visible light. The resin package 3 is provided on the substrate 1 by, for example, transfer molding so as to cover the light-emitting devices 2.

Multiple optical lenses 31 corresponding to the multiple light-emitting devices 2 are provided integrally on the top surface of the resin package 3. The optical lens 31 functions to converge and emit rays of light emitted from the light-emitting device 2. The optical lens 31 is a convex lens having a particular radius of curvature and having its optical axis S perpendicular to the top surface of the substrate 1.

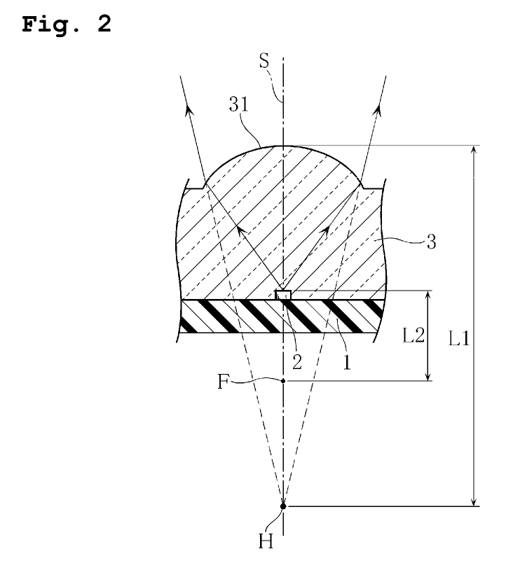

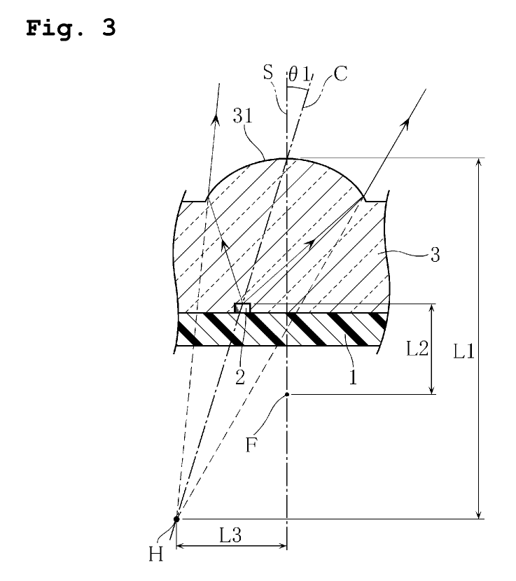

FIGS. 2 and 3 are schematic sectional views illustrating examples of the light-emitting device 2 and its corresponding optical lens 31.

In FIGS. 2 and 3, F represents the focal point of the optical lens 31 on its optical axis S. As shown in the same figures, the light-emitting device 2 is located at a position closer to the optical lens 31 than its focal point F. Thus, the rays outgoing from the optical lens 31, after the light emitted from the corresponding light-emitting device 2 is refracted during transmission therein, is more focused than the rays before transmission through the optical lens 31, although the emission direction is more diffused. When the rays outgoing from the optical lenses 31 are extended toward the substrate 1, the rays focus at a position spaced farther from the optical lens 31 than the light-emitting device 2 and the focal point F and, thus, the light-emitting device 2 seems as if the light is emitted from the focal position. In the present preferred embodiment, this focal position will be referred to as a virtual light-emitting region H. The distance L1 between the virtual light-emitting region H and the top of optical lens 31 is a value determined by the distance L2 between the actual light-emitting region (top face of light-emitting device 2) and the focal point F. For example, a decrease in the distance L2 makes the rays outgoing from the optical lens 31 closer to parallel light, consequently leading to elongation of the distance L1.

FIG. 2 shows a light-emitting device 2 provided in the center of a light-emitting module A1. In this case, the optical lens 31 is present in front of the light-emitting device 2, and the virtual light-emitting region H is present on the optical axis S of optical lens 31.

FIG. 3 shows a light-emitting device 2 provided at a position spaced from the center of the light-emitting module A1. In this case, the optical lens 31 is present at a position deviated from the front of the light-emitting device 2. That is, the straight line C connecting the top center of light-emitting device 2 and the top of the optical lens 31 is tilted from the optical axis S of optical lens 31 by an angle of θ1. The virtual light-emitting region H is present at a position deviated from the optical axis S by a distance of L3. The distance L3 is determined by the distance L1 and the angle θ1, according to the Formula: L3=L1×tan θ1.

As shown in FIG. 1, in the light-emitting module A1 in the present preferred embodiment, all virtual light-emitting regions H corresponding to respective light-emitting devices 2 are located almost at the same position. That is, the light-emitting device 2 located at a position deviated from the center of the light-emitting module A1 and its corresponding optical lens 31 are aligned optimally at an angle θ1, so that its virtual light-emitting region H lies on the optical axis S of optical lens 31 at the center of the light-emitting module A1. The phrase, “the virtual light-emitting regions H are located almost at the same position” in light-emitting module A1 indicates not only a case where the virtual light-emitting regions H lie precisely at the same position, but also a case where the positions of the virtual light-emitting regions H vary slightly because of an aberration of optical lenses 31. The same shall apply in the light-emitting modules A3 and A4 described below.

The light-emitting module A1 in the configuration described above can be used as a light source for various lighting fixtures. For example, when the light-emitting module A1 is used as a light source for illumination, the light-emitting module A1 when turned on seems visually as if the light-emitting devices 2 are emitting light from a single virtual light-emitting region H. Thus, with the light-emitting module A1, it is possible to improve the quality of the lighting fixture because the LED chips are not seen in a multiple dotted pattern, as in conventional lighting fixtures using a light source having multiple LED chips.

The light-emitting module A1, in which the light of the light-emitting devices 2 appears to be emitted from a single virtual light-emitting region H, can be used as a point light source having a relatively high light intensity and, thus, is usable in a wide variety of applications. For example, the light-emitting module A1 may be used as a substitute for the conventional light source in lighting fixtures containing, for example, an incandescent lamp as its light source. Accordingly, when the light-emitting module A1 in the present preferred embodiment is used as a light source for conventional lighting fixtures, the conventional optical system may be used as it is, only with replacement of the light source with the light-emitting module A1. This is also advantageous by reducing the installation cost because it is possible to reduce the number of parts newly produced for installing a light source of LED chips. When the power supplied to the light-emitting module A1 is alternating current, the power is supplied to the light-emitting module A1 via an AC-DC converting circuit, and a DC voltage is applied to the light-emitting device 2. The same shall apply in the light-emitting modules A2, A3, A4, and A5 described below.

In the light-emitting module A1, a resonant-cavity light-emitting diode (RC-LED) is preferably used as the light-emitting device 2. Because the RC-LED has a configuration in which reflecting mirrors in the laminated structure are provided on the top and bottom surfaces of a chip and also a particular light-emitting region on the top surface, it is possible to transmit the light emitted from the light-emitting device 2 to the optical lens 31 more efficiently by using a RC-LED as the light-emitting device 2. The same shall apply in the light-emitting modules A2, A3, A4, and A5 described below.

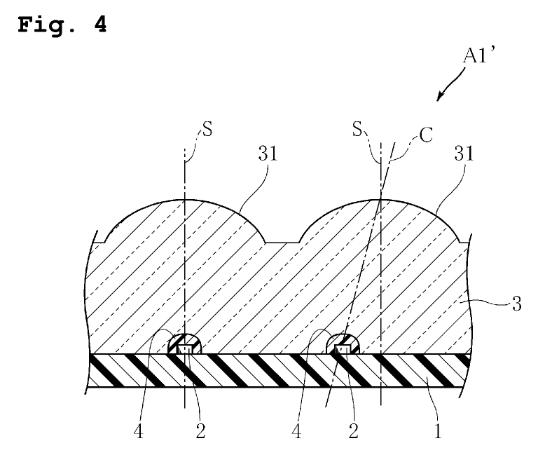

The light-emitting module according to another preferred embodiment may include a fluorescent substance for use as a white light source. FIG. 4 is a sectional view of the main area of a light-emitting module A1′ emitting white light in a modified embodiment of light-emitting module A1. The light-emitting module A1′ differs from the light-emitting module A1 above in that it has a mold unit including a fluorescent substance. The mold unit 4 containing the fluorescent substance, which includes a transparent epoxy resin as its principal component and a fluorescent substance dispersed in a small amount, covers the light-emitting device 2. The fluorescent substance-containing mold unit 4 includes a fluorescent substance in an amount suitable for the module to generate white light, by mixing the light emitted from the corresponding light-emitting device 2 (blue light) and the yellow light generated by excitation of a portion of the blue light in contact with the fluorescent substance. The fluorescent substance containing mold unit 4 is preferably small to the extent that it is seen as a dot. The light emitted from the fluorescent substance, when the light emitted from the corresponding light-emitting device 2 comes in contact with the fluorescent substance, is a scattered light, and the entire mold unit 4 including the fluorescent substance is seen as a light-emitting unit from outside of the light-emitting module A1′. However, as described above, because the mold unit 4 containing the fluorescent substance is small in size, the mold unit 4 containing the fluorescent substance may be regarded as a point light source and, thus, it is possible to use the light-emitting module A1′ as a point light source. The light-emitting modules A2, A3, A4, and A5 described below are also the same, in that the light-emitting module may have a configuration containing a fluorescent substance.

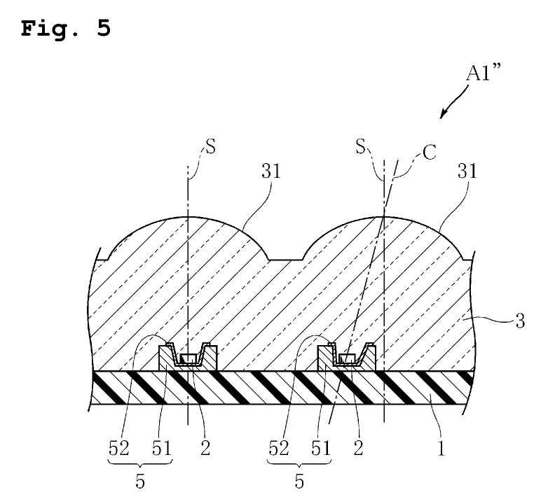

Alternatively, the light-emitting module may have a configuration having an auxiliary unit for efficiently directing the light emitted from the corresponding light-emitting device 2 toward the optical lens 31. FIG. 5 is a sectional view illustrating the main area of a light-emitting module A″ having an auxiliary unit in another modified preferred embodiment of the light-emitting module A1. The auxiliary unit 5 shown in the figure has a mounting unit 51 and a reflective film 52. The mounting unit 51 is a chip, for example, made of silicon, which is bonded onto the substrate 1. The mounting unit 51 preferably has a substantially circular or substantially elliptical opening on the top, and a tapered dent that narrows in the direction from the opening toward the bottom. The side and bottom walls in the dent are covered with the reflective film 52. The reflective film 52 is plated, for example, with Au, and has a smooth surface with a high light reflectance. The light-emitting device 2 is bonded to the bottom of the reflective film 52. The tapered area of the side wall of reflective film 52 encloses the light-emitting device 2, and is an area for reflecting the horizontal light from the light-emitting device 2 toward the corresponding optical lens 31 located above. In the light-emitting module A″ in such a configuration, a portion of the light emitted from the light-emitting device 2 is reflected by the reflective film 52 and efficiently advances to the corresponding optical lens 31. The same shall apply in the light-emitting modules A2, A3, A4, and A5 described below, in that the light-emitting module may have a configuration having an auxiliary unit for efficiently guiding the light emitted from the light-emitting device 2 to the corresponding optical lens 31.

Although not shown in FIG. 5, a shading unit projecting from the substrate 1 to a certain height may be provided between adjacent light-emitting devices 2 in the light-emitting module according to the present preferred embodiment. The configuration having such a shading unit is favorable for preventing unnecessary diffusion of the light emitted from the light-emitting device 2 and adequately guiding the light to the corresponding optical lens 31.

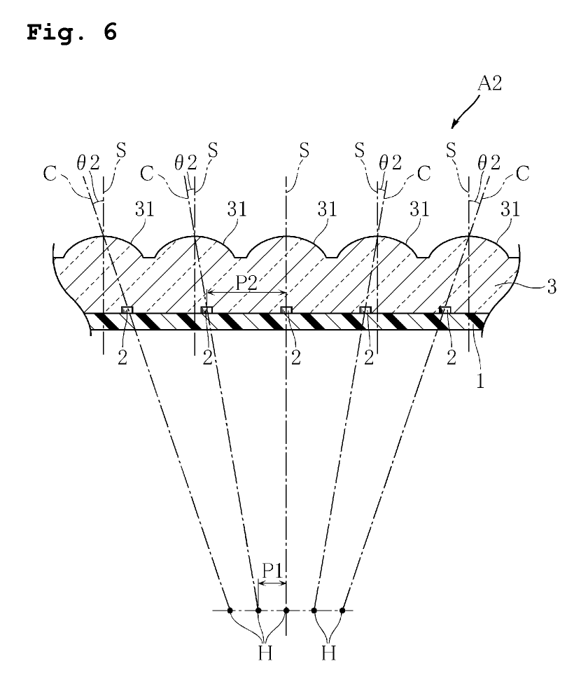

FIGS. 6 to 10 show other examples of the light-emitting module according to preferred embodiments of the present invention. In these figures, the same reference numbers are allocated to the same elements as those in the preferred embodiments above, and duplicate description thereof is omitted as needed.

In the light-emitting module A2 shown in FIG. 6, the angle θ2 between the straight line C connecting the top center of the light-emitting device 2 and the top of the optical lens 31 and the optical axis S of optical lens 31 is smaller than the corresponding angle θ1 in the light-emitting module A1. When the angle θ2 is smaller than the corresponding angle θ1 in the light-emitting module A1 in this manner, the deviation of the virtual light-emitting region H from the optical axis S becomes smaller than the deviation of the corresponding virtual light-emitting region H from the optical axis S in the light-emitting module A1 (distance L3). As a result, the virtual light-emitting regions H are not located in the same plane, but almost in the same plane. However, in the light-emitting module A2 as shown in FIG. 6, the alignment pitch P1 of the virtual light-emitting regions H becomes smaller than the alignment pitch P2 of the light-emitting devices 2. In the light-emitting module A2, the phrase “virtual light-emitting regions H lie almost on the same plane” is not restricted to a case where the virtual light-emitting regions H are aligned strictly on the same plane, but include a case where the positions of the virtual light-emitting regions H vary because of an aberration of optical lens 31. The same shall apply in the light-emitting module A5 described below.

When the light-emitting module A2 having such a unique configuration is used as a light source for illumination, the light-emitting module A2 when turned on appears visually as if the light-emitting devices 2 are emitting light from a single virtual light-emitting region H or adjacent multiple virtual light-emitting regions H. These virtual light-emitting regions H are observed as an integrated region because the alignment pitch P1 of virtual light-emitting regions H is smaller than the alignment pitch P2 of light-emitting devices 2. Thus, with the light-emitting module A2, it is possible to improve the quality of the lighting fixture because the LED chips are not seen in a multiple dotted pattern as in conventional lighting fixtures using a light source having multiple LED chips. The light-emitting module A2, in which the light of the light-emitting devices 2 appears to be emitted from a single virtual light-emitting region H, can be used as a point light source having a relatively high light intensity and, thus, is usable in a wide variety of applications.

In addition, because the virtual light-emitting regions H are aligned almost on the same plane in the light-emitting module A2, it is possible to reduce the fluctuation of light intensity on the projection surface, which is spaced by a certain distance from the optical lenses 31. When the light-emitting module A2 in such a configuration is used as a light source in an area where the light intensity on a particular plane is desirably uniform, such as the light source for a microscope, it is not necessary to use a light-scattering unit for providing a uniform light intensity, which consequently leads to prevention of a deterioration in irradiation efficiency and possibly to a reduction in power consumption.

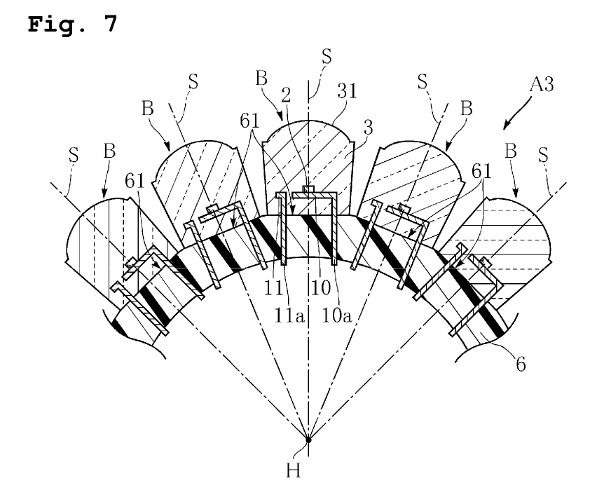

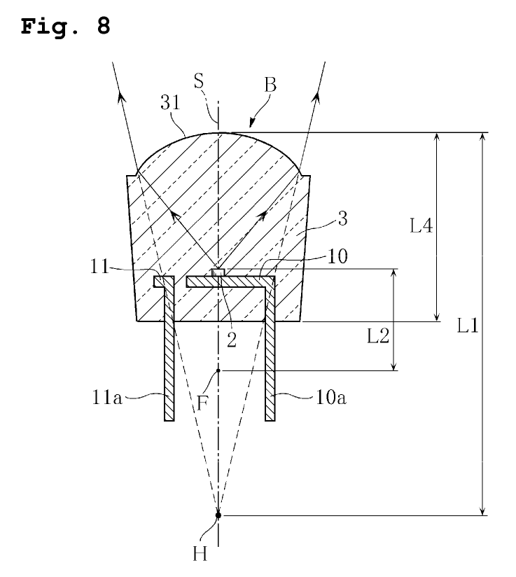

The light-emitting module A3 shown in FIG. 7 has multiple light-emitting units B and a supporting unit 6. As shown in FIG. 8, each light-emitting unit B has conductive plates 10 and 11, a light-emitting device 2, and a resin package 3. The conductive plates 10 and 11 are metal plates, for example copper, and the light-emitting device 2 is bonded onto the conductive plate 10. The top surface electrode of the light-emitting device 2 and the conductive plate 11 are electrically connected to each other with a gold wire (not shown in FIG. 8). A portion of the conductive plates 10 and 11 project from the resin package 3, and these projections become, respectively, terminals 10a and 11a.

An optical lens 31 is formed integrally on the top surface of the resin package 3. The optical lens 31 is a convex lens having a particular radius of curvature, which is located in front of the light-emitting device 2, and the optical axis S thereof is configured to extend in the direction that is substantially perpendicular to the top surface of the conductive plate 10. The light-emitting device 2 is located at a position closer to the optical lens 31 than its focal point F. Thus, in the light-emitting unit B, for the reason described above in the description of the light-emitting module A1, the rays of light emitted from the light-emitting device 2 refracted in the optical lens 31 during transmission is configured to focus in a virtual light-emitting region H at a position on the rays extending toward conductive plate 10 that is spaced farther from the optical lens 31 than the light-emitting device 2 and the focal point F.

The supporting unit 6 is, for example, made of a thermosetting resin such as phenol resin, and has a block shape having an almost spherical outer surface (hereinafter, referred to as spherical area). The radius of the spherical area of the supporting unit 6 is identical to the difference between the distance L1 from the top of the optical lens 31 to the virtual light-emitting region H and the height L4 of the light-emitting unit B. Connector units 61 for bonding the respective light-emitting units B are provided on the spherical area of supporting unit 6. The terminals 10a and 11a of a light-emitting unit B can be inserted into each connector unit 61 such that the optical axes S of optical lenses 31 extend in the radial direction from the center of the spherical area when the light-emitting units B are mounted. As shown in FIG. 7, the virtual light-emitting regions H corresponding to respective light-emitting units B are located almost at the same position (the center of the spherical area of supporting unit 6) in the light-emitting module A3. A common wiring (not shown in FIG. 7) electrically connecting to each terminal 10a of light-emitting unit B via the connector unit 61, and another common wiring (not shown in FIG. 7) electrically connecting to each terminal 11a of light-emitting unit B via the connector unit 61 are provided on the supporting unit 6.

It is possible to obtain an advantageous effect similar to that described for the light-emitting module A1 by using the light-emitting module A3 in such a configuration as a light source for a lighting fixture. That is, the light-emitting module A3 when turned on appears visually as if the light-emitting devices 2 are emitting light from a single virtual light-emitting region H. Thus, with the light-emitting module A3, it is possible to improve the quality of the lighting fixture because the LED chips are not seen in a multiple dotted pattern as in conventional lighting fixtures using a light source having multiple LED chips. In addition, the light-emitting module A3, in which the light of the light-emitting devices 2 appears to be emitted from a single virtual light-emitting region H, can be used as a point light source having a relatively high light intensity and is, thus, usable in a wide variety of applications.

In the light-emitting module A3, when the supporting unit 6 is made almost spherical and the light-emitting units B are mounted on the spherical area covering the entire supporting unit 6, it is possible to emit light out of the light-emitting module A3 in all directions almost at a uniform light intensity. The light-emitting module in such a configuration is favorable as a substitute for lighting fixtures having a reflector, and, for example, the light-emitting module A3 may be used as a substitute for a light source for conventional signals. Such a signal is indistinguishable from conventional signals using an incandescent lamp.

As described above, the light-emitting module in the configuration in which the light-emitting units B are mounted on the spherical area of the spherical supporting unit 6 while covering the entire surface may also be used as a substitute for a fluorescent lamp. That is, by placing the light-emitting module A3, for example, in a glass ball having a paint containing a fluorescent substance in a suitable amount coated on the internal surface thereof, it is possible to make the entire glass ball emit white or yellow light from a mixture of the blue light emitted from the light-emitting module A3 and the yellow light emitted from the fluorescent substance when struck by the blue light.

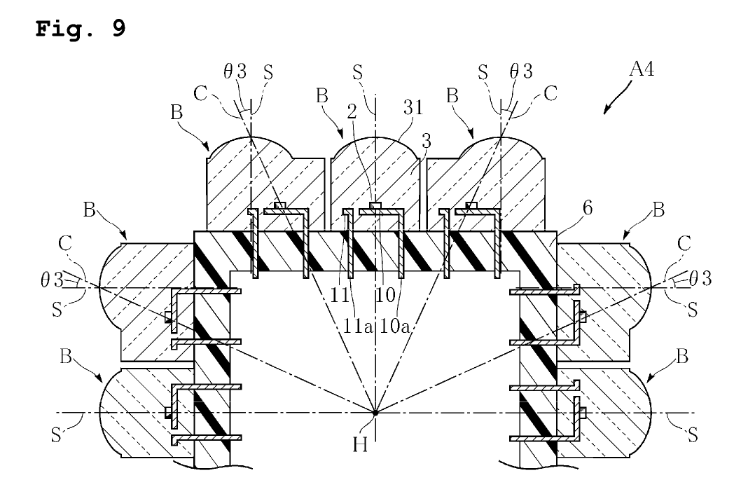

The supporting unit 6 is not limited to a spherical shape such as the light-emitting module A3, and a supporting unit having various shapes may be used. For example, the supporting unit 6 may be formed as a square tube or a cylinder, and the light-emitting units may be mounted on the surface thereof. FIG. 9 shows a light-emitting module A4 having a supporting unit 6 in a square tube shape. In this case, the light-emitting unit B preferably has a configuration in which the straight line C connecting the top center of the light-emitting device 2 and the top of the optical lens 31 is tilted from the optical axis S of optical lens 31 by a particular angle θ3. As shown in FIG. 9, the angles θ3 of respective light-emitting units B are optimized so that the virtual light-emitting regions H are located almost at the same position.

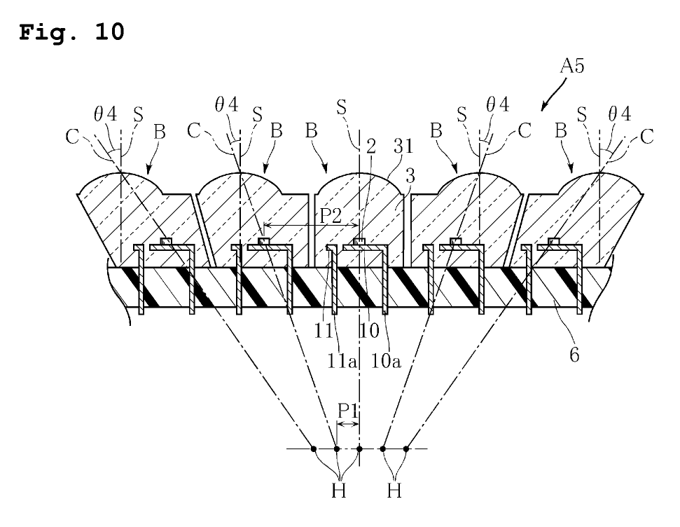

In another modified embodiment of the light-emitting module A4, the virtual light-emitting regions H are not located almost at the same position, but are aligned almost on the same flat plane. The light-emitting module A5 shown in FIG. 10 has a configuration in which light-emitting units B are aligned on a plate-shaped supporting unit 6. In the light-emitting module A5, the angle θ4 between the straight line C connecting the top center of light-emitting device 2 with the top of optical lens 31 and the optical axis S of optical lens 31 is made smaller than the corresponding angle θ3 in the light-emitting module A4. When the angle θ4 is smaller than the angle θ3 in light-emitting module A4, the deviation of the virtual light-emitting regions H from optical axes S becomes smaller than the deviation of the virtual light-emitting regions H in light-emitting module A4 from the optical axes S. As a result, the virtual light-emitting regions H are not located almost at the same position, but almost on the same plane. However, as shown in FIG. 10, the alignment pitch P1 of the virtual light-emitting regions H is smaller than the alignment pitch P2 of the light-emitting devices 2 in the light-emitting module A5.

It is possible to obtain an advantageous effect similar to that described for the light-emitting module A2 by using the light-emitting module A5 in such a configuration as a light source for lighting fixtures. The light-emitting module A5 when turned on appears visually as if the light-emitting devices 2 are emitting light from a single virtual light-emitting region H or adjacent multiple virtual light-emitting regions H. The virtual light-emitting regions H are observed as an integral region because the alignment pitch P1 of the virtual light-emitting regions H is smaller than the alignment pitch P2 of the light-emitting device 2. Thus, with the light-emitting module A5, it is possible to improve the quality of the lighting fixture because the LED chips are not seen in a multiple dotted pattern as in conventional lighting fixtures using a light source having multiple LED chips. In addition, the light-emitting module A5, in which the light of the light-emitting devices 2 appears to be emitted from a single, integral virtual light-emitting region H, can be used as a point light source having a relatively high light intensity and, thus, is usable in a wide variety of applications.

The light-emitting module and the light-emitting unit according to the present invention are not limited to the preferred embodiments described above. The specific configuration of each light-emitting module and light-emitting unit may be modified arbitrarily in any way.

The optical device used in the light-emitting module or the light-emitting unit according to the present invention is not limited to optical lenses, and may be, for example, a diffraction grating.

In the light-emitting unit according to the present invention, the supporting plate for mounting light-emitting devices is not limited to a conductive plate. For example, when a light-emitting unit is constructed with a surface electrode-type LED, the LED chips (light-emitting devices) may be mounted on an insulative substrate (supporting plate) carrying a particular conductor pattern.

The light-emitting device is not limited to an LED, and light-emitting devices other than LED (e.g., organic EL) may also be used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A light-emitting module comprising:
a substrate;
multiple light-emitting devices arranged on the substrate; and
a package enclosing the multiple light-emitting devices, the package having multiple optical devices corresponding to the multiple light-emitting devices that converge and emit rays of light emitted from each of the light-emitting devices; wherein
the package has virtual light-emitting regions spaced farther from the optical devices than the respective light-emitting devices when the converged rays of light are extended toward the substrate; and
the virtual light-emitting regions are located almost at the same position.

2. A light-emitting module comprising:
a substrate;
multiple light-emitting devices arranged on the substrate; and
a package enclosing the multiple light-emitting devices, the package having multiple optical devices corresponding to the multiple light-emitting devices that converge and emit rays of light emitted from each of the light-emitting devices; wherein
the package has virtual light-emitting regions spaced farther from the optical device than the light-emitting device when the converged rays of light are extended toward the substrate;
the virtual light-emitting regions are located almost on the same plane; and
an alignment pitch of the virtual light-emitting regions is smaller than an alignment pitch of the light-emitting devices.

3. A light-emitting module comprising:
multiple light-emitting units each including a substrate, multiple light-emitting devices arranged on the substrate, and a package enclosing the multiple light-emitting devices; wherein
each of the packages has multiple optical devices corresponding to the multiple light-emitting devices that converge and emit rays of light emitted from each of the light-emitting devices;
the package has virtual light-emitting regions spaced farther from the optical devices than the respective light-emitting devices when the converged rays of light are extended toward the substrate; and
the virtual light-emitting regions are located almost at the same position.

4. A light-emitting module comprising:
multiple light-emitting units each including a substrate, multiple light-emitting devices arranged on the substrate, and a package enclosing the multiple light-emitting devices; wherein
each of the packages has multiple optical devices that converge and emit rays of light emitted from each of the light-emitting devices;
the package has virtual light-emitting regions spaced farther from the optical devices than the respective light-emitting devices when the converged rays of the light are extended toward the substrate;
the virtual light-emitting regions are located almost on the same plane; and
an alignment pitch of the virtual light-emitting regions is smaller than an alignment pitch of the light-emitting devices.

5. The light-emitting module according to claim 1, further comprising a mold unit containing a fluorescent substance covering the light-emitting device.

6. The light-emitting module according to claim 2, further comprising a mold unit containing a fluorescent substance covering the light-emitting device.

7. The light-emitting module according to claim 3, further comprising a mold unit containing a fluorescent substance covering the light-emitting device.

8. The light-emitting module according to claim 4, further comprising a mold unit containing a fluorescent substance covering the light-emitting device.

9. The light-emitting module according to claim 1, further comprising a plurality of mounting units having inwardly tapered walls and a bottom covered with a reflective film, wherein a respective one of the light-emitting devices is arranged at the bottom of each mounting unit.

10. The light-emitting module according to claim 2, further comprising a plurality of mounting units having inwardly tapered walls and a bottom covered with a reflective film, wherein a respective one of the light-emitting devices is arranged at the bottom of each mounting unit.

11. The light-emitting module according to claim 3, further comprising a plurality of mounting units having inwardly tapered walls and a bottom covered with a reflective film, wherein a respective one of the light-emitting devices is arranged at the bottom of each mounting unit.

12. The light-emitting module according to claim 4, further comprising a plurality of mounting units having inwardly tapered walls and a bottom covered with a reflective film, wherein a respective one of the light-emitting devices is arranged at the bottom of each mounting unit.

13. The light-emitting module according to claim 1, wherein the substrate includes a supporting unit and connector units arranged to connect the light-emitting units to the supporting unit, wherein the supporting unit has a spherical or tubular outer surface.

14. The light-emitting module according to claim 2, wherein the substrate includes a supporting unit and connector units arranged to connect the light-emitting units to the supporting unit, wherein the supporting unit has a spherical or tubular outer surface.

15. The light-emitting module according to claim 3, wherein the substrate includes a supporting unit and connector units arranged to connect the light-emitting units to the supporting unit, wherein the supporting unit has a spherical or tubular outer surface.

16. The light-emitting module according to claim 4, wherein the substrate includes a supporting unit and connector units arranged to connect the light-emitting units to the supporting unit, wherein the supporting unit has a spherical or tubular outer surface.

17. A light-emitting unit comprising:
a substrate, light-emitting devices arranged on the substrate, and a package enclosing the light-emitting device; wherein
the package has multiple optical devices that converge and emit rays of light emitted from each of the light-emitting devices; and
the package has virtual light-emitting regions spaced farther from the optical devices than the respective light-emitting devices when the converged rays of the light are extended toward the substrate.

18. The light-emitting unit according to claim 17, further comprising a mold unit containing a fluorescent substance covering the light-emitting device.

19. The light-emitting module according to claim 17, further comprising a plurality of mounting units having inwardly tapered walls and a bottom covered with a reflective film, wherein a respective one of the light-emitting devices is arranged at the bottom of each mounting unit.

20. The light-emitting module according to claim 17, wherein the substrate includes a supporting unit and connector units arranged to connect the light-emitting units to the supporting unit, wherein the supporting unit has a spherical or tubular outer surface.
